(19) United States
(12) Patent Application Publication
(10) Pub. No.: US 2015/0347818 A1
(43) Pub. Date: Dec. 3, 2015

(54) METHOD, SYSTEM, AND APPLICATION FOR OBTAINING COMPLETE RESOURCE ACCORDING TO BLOB IMAGES

(71) Applicant: LANDSCAPE MOBILE, INC., Beijing (CN)

(72) Inventor: Tian BAI, Beijing (CN)

(73) Assignee: LANDSCAPE MOBILE, INC.

(21) Appl. No.: 14/725,251

(22) Filed: May 29, 2015

(30) Foreign Application Priority Data
May 30, 2014 (CN) 201410240761.4

(51) Int. Cl. G06K 9/00

(52) U.S. Cl. CPC G06K 9/00147; G06K 9/0014; G06K 2209/05

(57) ABSTRACT

A method for obtaining a final complete resource includes obtaining a blob image, extracting rough blob information from the blob image through image recognition, searching for a candidate complete resource corresponding to the blob image according to the rough blob information, and determining the final complete resource according to the candidate complete resource. The blob image is at least a part of the final complete resource shown in an image form. The rough blob information contains at least two characters or words recognized from the blob image.

### CROSS REFERENCE TO RELATED APPLICATION

This application claims priority to and the benefit of Chinese Patent Application Serial No. 201410240761.4, filed with the State Intellectual Property Office of P.R. China on May 30, 2014. The content of the above-referenced application is incorporated herein by reference in its entirety.

### FIELD

The present disclosure relates to mobile internet technology and, more particularly, to a method, system, and application for obtaining complete resource according to blob images.

### BACKGROUND

When reading articles using a front-end application, such as a mobile browser, Weibo (microblog), WeChat, or a news client, on an intelligent mobile device, a user may sometime want to save an article. Conventionally, the user may use a saving function provided by the front-end application, or may pass a Uniform Resource Identifier (URI) from the front-end application to a reading saving application by, for example, coping and pasting, or invoking between applications. A URI may be a Uniform Resource Locator (URL) or a Uniform Resource Name (URN). Web resources are mainly identified and located by their URLs. A front-end application is application software with which the user is interacting through a graphical interface.

However, the conventional technologies have some drawbacks. For example, using the saving functions separately provided by different front-end applications requires that each front-end application provides the saving function, and the resources cannot be saved to one same place. Further, since the functional details and user experiences, such as locations of the saving button, are different for different applications, the user's learning cost is increased.

Passing the URIs from front-end applications to a reading saving application also has drawbacks. For example, copying/pasting does not work well in this scenario. Further, because the iOS system does not support invocation between applications, copying/pasting may have to be used in most cases. A front-end application on the Android system may support the invocation of a reading saving application, so that the user can pass the URI by hitting a “share” button. However, some problems still exist in the Android system. For example, the user still needs to learn since the functional details and user experiences are different for different applications, and the user experience may be impacted by switching between different applications. Moreover, the approach of passing URI cannot realize certain advanced functions, such as recording the user's reading position or the highlighted notes made by the user in the front-end application.

In view of the above, compared to URIs and texts, images may be a more friendly medium for recording and distributing in the mobile internet era. Below are some exemplary advantages of using images over using URIs or texts.

1) Screenshots or photos can be continuously taken, and then read in a target application. On the other hand, URIs and texts cannot be continuously copied. Each time a URI or text is copied, the target application has to be opened to paste the copied URI or text. This is inconvenient since the user has to switch between different applications.

2) Using screenshots or photos to make recording is more convenient than selecting, copying, and pasting a long URI or text.

3) All mainstream devices and platforms support screenshot or photos. Support by the front-end application is not needed. For example, whether watching the news in the mobile browser or the news client, the user can record what he is reading by screenshot without the need for the mobile browser or the news client to provide a button. Further, a unified operation of screen capturing eliminates the user's learning costs because the user does not need to find different locations of the buttons in different APPs (application software on an intelligent mobile device).

4) Images recorded by screen capturing or photographing are saved in a storage space maintained by the system. Any application software that has acquired authorization from the user can access the images. In contrast, information saved using the built-in saving function of a particular application, such as the news client, cannot be accessed by other application software.

5) Images are more attractive to readers than a long URI or text when being shared in a social network. Further, some social network applications have limits on the text length. For example, Weibo does not allow a URI or text that is longer than 140 characters.

However, the information contained in an image is often only part of a certain complete resource, i.e., such information is merely “blob information,” which needs to be further processed to obtain the complete resource.

### SUMMARY

In accordance with the present disclosure, there is provided a method for obtaining a final complete resource. The method includes obtaining a blob image, extracting rough blob information from the blob image through image recognition, searching for a candidate complete resource corresponding to the blob image according to the rough blob information, and determining the final complete resource according to the candidate complete resource. The blob image is at least a part of the final complete resource shown in an image form. The rough blob information contains at least two characters or words recognized from the blob image.

Also in accordance with the present disclosure, there is provided a method for saving reading on an intelligent mobile terminal. The method includes scanning an image library automatically to screen out a blob image, extracting rough blob information from the blob image through image recognition, searching for a reading resource corresponding to the blob image as a candidate complete resource according to the rough blob information, and determining a final complete resource according to the candidate complete resource. The rough blob information contains at least two characters or words recognized from the blob image.

Also in accordance with the present disclosure, there is provided a system for obtaining a final complete resource. The system includes a blob image obtaining module, an extracting module, a searching module, and a final complete resource determining module. The blob image obtaining module is configured to obtain a blob image. The blob image is at least a part of the final complete resource shown in an image form. The extracting module is configured to extract rough blob information from the blob image through image recognition. The rough blob information contains at least two characters or words recognized from the blob image. The searching module is configured to search for a candidate complete resource corresponding to the blob image according to the rough blob information. The final complete resource determining module is configured to determine the final complete resource according to the candidate complete resource.

Also in accordance with the disclosure, there is provided a system for saving reading on an intelligent mobile terminal. The system includes an extracting module, a searching module, and a final complete resource determining module. The extracting module is configured to extract rough blob information from a blob image through image recognition after scanning an image library automatically to screen out the blob image. The rough blob information contains at least two characters or words recognized from the blob image. The searching module is configured to search for a reading resource corresponding to the blob image as a candidate complete resource according to the rough blob information. The final complete resource determining module is configured to determine a final complete resource according to the candidate complete resource.

It should be understood that, the above general description and the detailed description below are merely exemplary and explanatory, and do not limit the present disclosure.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 is a flowchart showing a method for obtaining a final complete resource according to blob images, according to an exemplary embodiment.

FIG. 2 is a flowchart showing a method for saving reading on an intelligent mobile terminal, according to an exemplary embodiment.

FIG. 3 is a block diagram showing a system for obtaining a final complete resource according to blob images, according to an exemplary embodiment.

FIG. 4 is a block diagram showing a system for saving reading on an intelligent mobile terminal, according to an exemplary embodiment.

FIG. 5 illustrates an interface of a reading saving application on an intelligent mobile terminal, according to an exemplary embodiment.

### DETAILED DESCRIPTION

Hereinafter, embodiments consistent with the present disclosure will be described in reference to the drawings. Wherever possible, the same reference numbers will be used throughout the drawings to refer to the same or like parts. The embodiments described herein are used merely to illustrate and explain rather than to limit the embodiments of the present disclosure.

In the present disclosure, unless otherwise specified, the following terms should be understood as described below.

“Complete resource” refers to a complete webpage resource that can be identified by a URI.

“Text resource” refers to a complete resource mainly containing text, such as an article, a forum post, a social network post, or an article introduction.

“Blob image” refers to a part or all of a complete resource shown in the form of image, such as a screenshot captured while a user is reading an article in a mobile browser, an image automatically generated by an article and shared in Weibo, a photographic record of a page of a book taken while being read.

“Rough blob information” refers to information contained in a blob image and obtained after analysis and extraction. It may contain, for example, main text, a title, an icon, an address, etc.

“Blob information” refers to information that is revised or confirmed after comparing the rough blob information with the complete resource.

“Mobile application/App” refers to application software on an intelligent mobile device.

“Front-end application (subject application)” refers to application software with which the user is interacting through a graphical interface. On an intelligent mobile device, often times, there is only one front-end application at a same time, which occupies most of a screen area. Therefore, taking a photograph or screenshot of the device will record an interface of the front-end application in an image, and thus the front-end application is also referred to as a subject application.

“Image metadata” refers to a basic attribute or basic attributes of an image file that can be read out without decoding pixel information of the image file, such as pixel resolution, creation date, file size etc.

Identifying, recording, distributing, and accessing network resources are the foundation of Internet applications. On a desktop device, the most common media for using resources is URI. In many scenarios of using a mobile device, however, images become a more friendly media than URI or text for recording and distributing.

However, the information contained in an image is often only part of a certain complete resource, i.e., such information is merely “blob information,” which needs to be further processed to obtain the complete resource. The processing may include, for example, obtaining the blob information through analysis of images, searching for the complete resource through the blob information, and restoring a relationship between the blob information and the complete resource.

According to the present disclosure, a method and a system for obtaining the complete resource are provided. Further, a mobile application that saves reading primarily using screenshots as the media is provided. The application guides a user to take screenshots no matter which front-end application the user is using for reading. By opening this application, the user can see all the text resources that he saved, in which the blob information is highlighted.

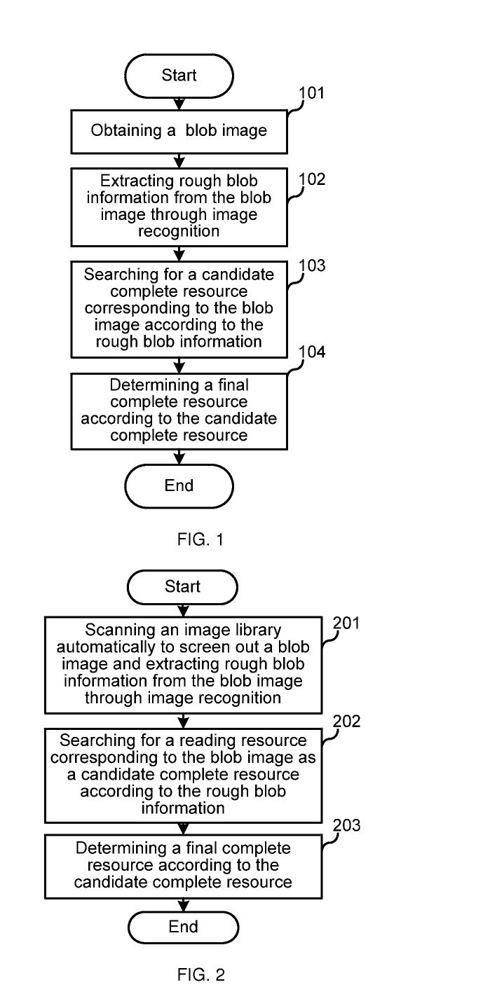

FIG. 1 is a flowchart showing an exemplary method for obtaining a final complete resource according to blob images, consistent with embodiments of the present disclosure. As shown in FIG. 1, at 101, a blob image is obtained, which is at least a part of the final complete resource, shown in the form of an image. The blob image may include a screenshot or a photograph, such as, for example, a screenshot taken while a user is reading an article in a mobile browser, an image automatically generated by an article and shared to Weibo, a photographic record of a page of a book being read by the user, or an existing image that is selected.

Photographing (usually a built-in feature of a mobile device) and screen capturing are default functions provided by an operating system and the device, which do not rely on a third-party application. Images obtained by photographing or screen capturing are stored at a location specified by the operating system, and all application software can access the images with user authorization. However, some operating systems separate the images obtained by photographing and screen capturing (for example, stored at different locations), while some operating systems require application software check some attributes to distinguish between the two types of images.

Referring to FIG. 1, at 102, rough blob information is extracted from the blob image through image recognition. The rough blob information contains at least two characters or words recognized from the blob image, and may include main text, a title, an icon, or a website address, etc.

At 103, a candidate complete resource corresponding to the blob image is searched for according to the rough blob information.

At 104, the final complete resource is determined according to the candidate complete resource. The final complete resource may include a web resource that can be identified by a URI. If there is more than one candidate complete resource, then the candidate complete resource that is the closest is chosen as the final complete resource. In some embodiments, determining the candidate complete resource that is the closest includes scoring the candidate complete resources by comparing them against the rough blob information and finding the one candidate complete resource that has the highest score.

In some embodiments, searching for the candidate complete resource in 103 further includes searching for the candidate complete resource using a self-built search engine and resource library according to the rough blob information, and invoking a third-party search service if no candidate complete resource can be found in the self-built search engine and resource library.

According to the disclosure, a small-scale search engine (including a resource library) may be built based on open-source software for the purpose of searching for the complete resource, and such a search engine is referred to as a “self-built search engine.” Searching for the complete resource may be performed by a third-party search service invoked by a URI or an application programming interface (API), or by the self-built search engine. In some embodiments, the self-built search engine is used first and then the third-party search service is invoked if no candidate complete resource can be found by the self-built search engine. According to the disclosure, the third-party search service may include, for example, Google or Twitter site search.

Consistent with embodiments of the present disclosure, searching for the candidate complete resource first in the self-built search engine and resource library increases the searching speed for those candidate complete resources that exist in the self-built search engine and resource library.

In some embodiments, searching for the candidate complete resource in 103 further includes determining whether a word frequency of a character or word in the rough blob information is lower than a predetermined value, and removing the character or word in the rough blob information that is random or has a word frequency lower than the predetermined value. Removing the character or word in the rough blob information that is random or has a word frequency lower than the predetermined value may eliminate the situation that no result can be found due to misrecognition of a word.

In some embodiments, searching for the candidate complete resource in 103 further includes searching for the candidate complete resource directly or attempting to access and search using an account set by the user for the candidate complete resource that requires login or authorization.

The above-described three exemplary approaches of searching for the candidate complete resource according to different criteria can be implemented individually or in any combination. That is, a server can attempt to perform one or more searches to acquire one or more candidate complete resources according to at least one of the searching locations, the searching conditions, or the requirement for login or authorization. Further, the order of the attempt searches according to different criteria is not fixed, and may be arranged according to specific needs.

In some embodiments, after the searching for the candidate complete resource corresponding to the blob image according to the rough blob information in 103 of FIG. 1, the rough blob information is iteratively compared with the candidate complete resource. The rough blob information is revised using the candidate complete resource according to the comparison result, and a candidate complete resource is searched for in a smaller scope according to the revised rough blob information. Such an approach increases the accuracy of finding the complete resource.

In some embodiments, after the determination of the final complete resource according to the candidate complete resource in 104 of FIG. 1, the final complete resource is stored in a server. Storing the final complete resource may ensure the availability of the complete resource for a long time. Nevertheless, storing the final complete resource is not necessary. For example, for the resources in the self-built resource library, only relevant information, rather than the final complete resource, may need to be stored. In addition, the final complete resource can be sent to a client for storing.

In some embodiments, after the determination of the final complete resource according to the candidate complete resource in 104, the final complete resource is displayed on a client's screen. An input signifying a determination result for the final complete resource is received from an input device of the client, and the method of extracting the rough blob information and/or the method of searching for the candidate complete resource are modified according to the input. In this way, the accuracy can be improved.

FIG. 2 is a flowchart showing an exemplary method for saving reading on an intelligent mobile terminal, consistent with embodiments of the present disclosure. As shown in FIG. 2, at 201, an image library is automatically scanned to screen out a blob image and rough blob information is extracted from the blob image through image recognition. The rough blob information contains at least two characters or words recognized from the blob image. At 202, a reading resource corresponding to the blob image is searched for according to the rough blob information, as a candidate complete resource. At 203, a final complete resource is determined according to the candidate complete resource. If there is more than one candidate complete resource, then the candidate complete resource that is the closest is chosen as the final complete resource.

In some embodiments, the image library stores blob images that mainly include screenshots. Correspondingly, before the automatic scanning of the image library to screen out the blob image (201 in FIG. 2), when a screen capturing signal is detected by the intelligent mobile terminal, a screenshot of reading contents currently displayed on a screen is acquired as a blob image, which is at least a part of a final complete resource shown in the form of an image. The blob image acquired by screen capturing is then stored in the image library specified by the operating system of the intelligent mobile terminal.

Since all mainstream devices and platforms support the screen capturing operation, it is not limited by front-end applications and thus the user's learning costs for finding respective locations of saving buttons in different applications is eliminated. By reading all of the screenshots in the storage space maintained by the system, the savings in different front-end applications can be centralized in a reading saving application. Further, screenshots can be taken continuously without the need to switch between applications.

In some embodiments, acquiring screenshots and saving the acquired screenshots are performed by the operating system rather than by the reading saving application. Further, in some embodiments, besides screenshots, an input to the reading saving application may also include photos obtained by photographing, in addition to screenshots.

In some embodiments, the rough blob information extracted from the blob image may include at least one of name and type of the front-end application, whether an interface of the front-end application matches a known pattern, text, link, source site of text resource, title, time stamp, or author.

In some embodiments, after the extraction of the rough blob information from the blob image (201 in FIG. 2), a category of the rough blob information is determined, and the manner of searching and obtaining the candidate complete resource is determined. Determining the category of the rough blob information includes determining, for example, whether the rough blob information is a part of an article, a part of a forum post, all or a part of a social networking post, or an article introduction. If the rough blob information is an article introduction, it is further determined whether a certain link needs to be followed to obtain the final complete resource. Further, the manner of searching and obtaining a text resource includes searching locations, searching conditions, or requirement for login or authorization, as described above.

In some embodiments, before the acquisition of the screen shot of reading contents currently displayed on a screen, the reading saving application requests a permission to read the image library. The automatic scanning of the image library in 201 includes the reading saving application automatically detecting in the background whether there's a new screenshot, before the user opens the reading saving application. Therefore, the reading saving application can achieve automatic detection and screening, without waiting for the user to open the reading saving application. By automatically detecting new screenshots, the reading saving application can preliminarily screen out the ones having enough information in order to analyze and search for the final complete resource.

In some embodiments, in addition to the automatic detection and screening, manual selection is also supported to choose the blob images.

According to the present disclosure, permission to read the local photos is requested when an APP is first started. The user can take screenshot when using any front-end application. The reading saving application automatically detects new screenshots and preliminarily screens out the ones having enough information to analyze and obtain the final complete resource (a web article), without waiting for the user to open the reading saving application. When the user opens the reading saving application, all acquired articles are in a list and the user only needs to click to read. In particular, the user can see the results of the final complete resources corresponding to, for example, one hundred blob images acquired beforehand by the reading saving application, without the need to wait for the corresponding result of the analysis and searching of the blob image every time one blob image is input. That is, analyzing and searching for the blob images by the reading saving application and querying the final complete resources by the user are asynchronous. Furthermore, the final complete resource corresponding to each blob image in the list is definite, and the user does not need to choose.

In some embodiments, at 201 of FIG. 2, the blob image is screened out according to one of image meta-data, small region features, or overall image features, or any combination thereof. The image meta-data are basic attributes of an image file that can be read out without decoding pixel information of the image file. The basic attributes of an image file include pixel resolution, creation date, file size, and etc. The small region features mainly determine whether the image is possibly a screenshot of a cellphone by recognizing whether the top of the image contains a status bar and a battery icon. The overall image features determine whether the image is possibly a screenshot of a cellphone by image resolution or size. Whether a large section of texts exists is determined by checking a color histogram of the image as a whole.

In some embodiments, before extracting the rough blob information in 201 of FIG. 2, the blob image is preprocessed by recognizing and extracting areas containing valid information, binarizing a text area, and compressing. That is, the blob image is preprocessed in the client-side before being uploaded to a server. As a result, the amount of uploaded data and computational load of the server can be reduced effectively.

In some embodiments, in 201 of FIG. 2, optical character recognition (“OCR”) is used for the image recognition. The OCR technique includes, for example, Tesseract that is mainly for English-text OCR and the Chinese-text OCR solution provided by Hanwang Technology.

In some embodiments, after determining the final complete resource according to the candidate complete resource in 203 of FIG. 2, a relationship, including a position relationship, between the blob information and the final complete resource is restored and recorded. Further, the final complete resource is presented to the user in a friendly format and the blob information is highlighted. The friendly format includes automatically scrolling to a position of the blob information so that the user can continue reading from the last position and/or select the blob information.

The methods consistent with embodiments of the present disclosure can be realized by, for example, software, hardware, or firmware. Instruction codes for realizing the methods can be stored in a computer accessible memory, including a non-transitory computer-readable storage medium, which may be, for example, permanent or modifiable, volatile or non-volatile, solid-state or non-solid, fixed or replaceable. The memory may be, for example, a programmable array logic (“PAL”), a random access memory (“RAM”), a programmable read only memory (“PROM”), a read-only memory (“ROM”), an electrically erasable programmable ROM (“EEPROM”), a floppy disc, an optical disc, or a digital versatile disc (“DVD”).

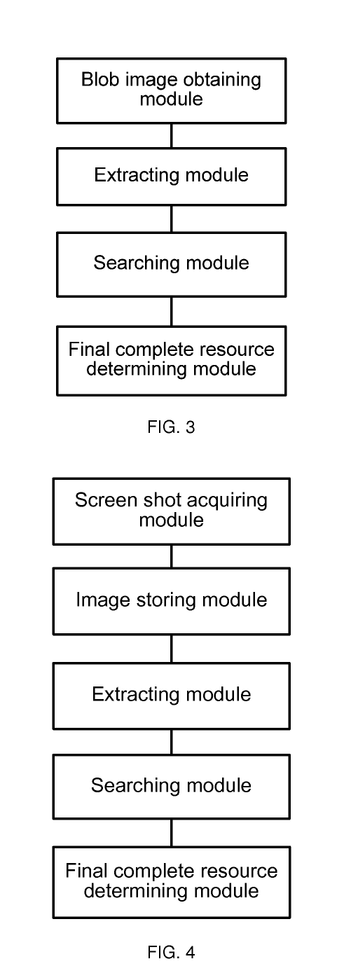

FIG. 3 is a block diagram showing an exemplary system for obtaining a final complete resource according to blob images, consistent with embodiments of the present disclosure. The system includes a blob image obtaining module, an extracting module, a searching module, and a final complete resource determining module.

The blob image obtaining module is configured to obtain a blob image, which is at least part of the final complete resource, shown in the form of an image. The blob image may include a screenshot or a photograph, such as, for example, a screenshot taken while a user is reading an article in a mobile browser, an image automatically generated by an article and shared to Weibo, a photographic record of a page of a book being read by the user, or an existing image that is selected.

The extracting module is configured to extract rough blob information from the blob image through image recognition. The rough blob information contains at least two characters or words recognized from the blob image, and may include main text, a title, an icon, or a website address, etc.

The searching module is configured to search a candidate complete resource corresponding to the blob image according to the rough blob information;

The final complete resource determining module is configured to determine the final complete resource according to the candidate complete resource. The final complete resource may be a web resource that can be identified by a URI. If there is more than one candidate complete resource, then the candidate complete resource that is the closest is chosen as the final complete resource. In some embodiments, determining the candidate complete resource that is the closest includes scoring the candidate complete resources by comparing them against the rough blob information and finding the one candidate complete resource that has the highest score.

In some embodiments, the searching module includes a self-built searching submodule and a third-party searching submodule. The self-built searching submodule is configured to search for the candidate complete resource using a self-built search engine and resource library according to the rough blob information. The third-party searching submodule is configured to revoke a third-party search service if no candidate complete resource can be found in the self-built search engine and resource library. The third-party search service may include, for example, Google or Twitter site search.

In some embodiments, the searching module also includes a word frequency determining submodule and a removing submodule. The word frequency determining submodule is configured to determine whether a word frequency of a character or word in the rough blob information is lower than a predetermined value. The removing submodule is configured to remove the character or word in the rough blob information that is random or has a word frequency lower than the predetermined value.

In some embodiments, the searching module also includes a direct-searching submodule and a login-searching submodule. The direct-searching submodule is configured to search for the candidate complete resource directly. The login-searching submodule is configured to attempt to access and search using the account set by a user for the candidate complete resource that requires login or authorization.

In the present invention, network resources are accessed with images instead of traditional media such as URI or text, and the final complete resource is obtained according to the rough blob information extracted from the blob image. This is more convenient for the user to record and access network resources and provides a good user experience.

Operation and further details of the system shown in FIG. 3 are similar to those of the methods described above in connection with, for example, FIG. 1, and thus are not repeated here.

The system shown in FIG. 3 may include other modules. For example, the system may further include an iteratively comparing and revising module. After the searching module finds the candidate complete resource corresponding to the blob image, the iteratively comparing and revising module iteratively compares the rough blob information with the candidate complete resource, revises the rough blob information using the candidate complete resource according to the comparison result, and searches for the candidate complete resource in a smaller scope according to the revised rough blob information.

In some embodiments, the system may further include a storing module configured to store the final complete resource in a server after the final complete resource is determined.

In some embodiments, the system may further include a displaying module configured to display the final complete resource on a client's screen, and a modifying module configured to receive an input signifying a determination result for the final complete resource from an input device of the client, and modifying the method of extracting the rough blob information and/or the method of searching for the candidate complete resource according to the input.

FIG. 4 is a block diagram showing an exemplary system for saving reading on an intelligent mobile terminal. As shown in FIG. 4, the system includes an extracting module, a searching module, and a final complete resource determining module. The extracting module is configured to extract rough blob information from a blob image through image recognition after automatically scanning an image library to screen out the blob image. The rough blob information contains at least two characters or words recognized from the blob image. The searching module is configured to search for a reading resource corresponding to the blob image according to the rough blob information, as a candidate complete resource. The final complete resource determining module is configured to determine a final complete resource according to the candidate complete resource. If there is more than one candidate complete resource, then the final complete resource determining module chooses the candidate complete resource that is the closest as the final complete resource. In some embodiments, determining the candidate complete resource that is the closest includes scoring the candidate complete resources by comparing them against the rough blob information and finding the one candidate complete resource that has the highest score.

In some embodiments, the image library stores blob images that mainly include screenshots. The system, as shown in FIG. 4, further includes a screenshot acquiring module and an image storing module. The screenshot acquiring module is configured to acquire a screenshot of reading contents currently displayed on a screen as a blob image, when a screen capturing signal is detected by the intelligent mobile terminal. The acquired blob image is at least a part of a final complete resource shown in the form of an image. The image storing module is configured to store the blob image acquired by screen capturing in the image library specified by the operating system of the intelligent mobile terminal.

In some embodiments, the system for saving reading on an intelligent mobile terminal further includes a preprocessing module configured to preprocess the blob image by, for example, recognizing and extracting areas containing valid information, binarizing a text area, and compressing.

In some embodiments, the system for saving reading on an intelligent mobile terminal further includes a relationship restoring and recording module and a presenting module. The relationship restoring and recording module is configured to restore and record a relationship, including a position relationship, between the blob information and the final complete resource. The presenting module is configured to present the final complete resource to the user in a friendly format with the blob information highlighted. The friendly format includes automatically scrolling to a position of the blob information so that the user can continue reading from the last position and/or selecting the blob information.

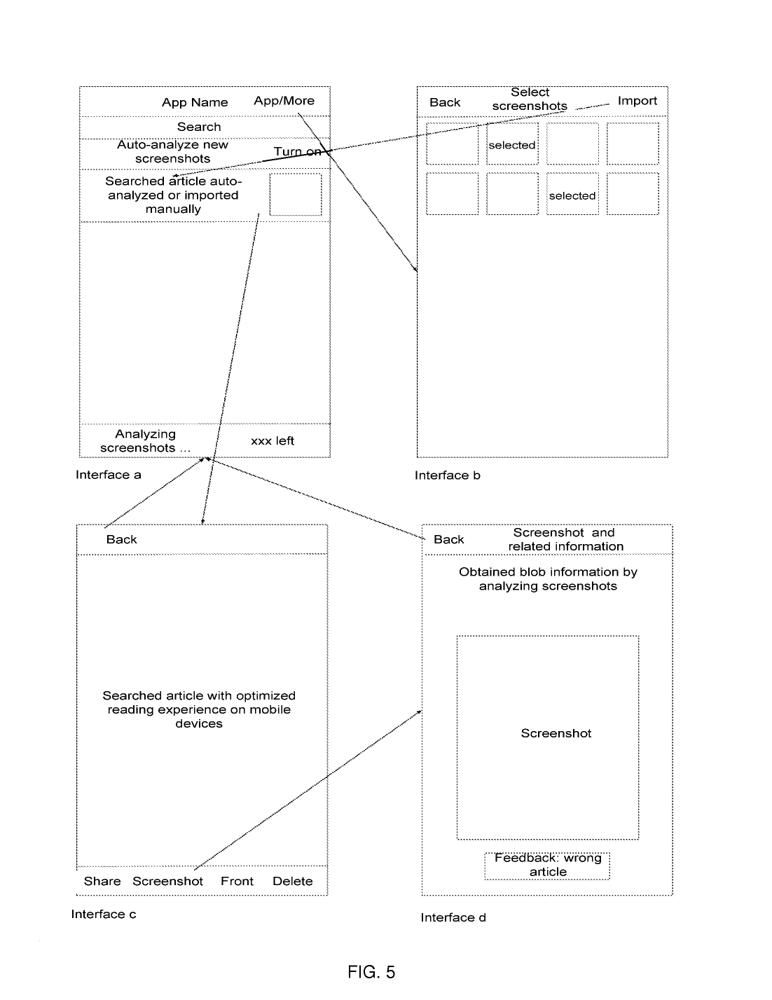

FIG. 5 schematically shows an exemplary interface of the reading saving application on an intelligent mobile terminal, which provides a friendly format to the user. Specifically, as shown in FIG. 5, interface a, interface b, interface c, interface d, as shown in the figure, appear respectively at different stages of using the reading saving application.

Specifically, interface a can be set to turn on/off the function of automatically analyzing new screenshots. If the function of automatically analyzing new screenshots is turned on, the reading saving application can obtain blob images by automatically detecting and screening, rather than waiting for the user to open the application for saving reading. By automatically detecting new screenshots, the reading saving application can preliminarily screen out the ones having enough information in order to analyze and search for the final complete resource.

In some embodiments, in addition to automatically detecting and screening blob images, the reading saving application can be set to manually import screenshots. If the user clicks the manual-importing key in interface a, the reading saving application switches to interface b.

Interface b provides thumbnails of multiple screenshots for the user to choose. In some embodiments, the user can select multiple screenshots. When the user clicks an import button in interface b, the reading saving application returns to interface a and notifies the user that it is analyzing the selected screenshot(s). After the screenshot analysis is completed, articles found according to the selected screenshot(s) are listed in a tabular form, accompanied with figures in the articles. The user can then click on a found article to enter interface c.

In interface c, the found article is opened and the reading experience of the mobile device is optimized. In addition, in interface c, fonts can be set or the article can be shared, or an instruction may be received to jump to interface d.

In interface d, the user can provide feedback including whether the found article is wrong.

Further, the user can return to interface a from either interface c or interface d, to read other articles found by automatically analyzing or manually importing the screenshots.

Operation and details of the interface of the reading saving application shown in FIG. 5 are similar to those described above in connection with methods, and thus are not repeated here.

It should be noted that units in a device consistent with embodiments of the present disclosure are logical units. A logic unit can be a physical unit or a part of a physical unit, or can include several physical units. Further, a device consistent with embodiments of the present disclosure may also include other units that are not described above.

Moreover, it should be noted that in the description and the following claims of the present disclosure, relationship terms, such as first or second, are merely used to distinguish one entity or operation from another entity or operation, but do not require or indicate any practical relation or sequence existing between these entities or operations. Further, the term “include,” “comprise,” or any other variants thereof are nonexclusive. Therefore, a process, method, article, or equipment including a series of elements not only includes those elements, but also includes other elements, which are not expressly listed, or inherent elements of such process, method, article, or equipment. Without further limitations, the element defined by the phrase “include a” does not exclude additional similar elements from existing in the process, method, article, or equipment of this element.

The present disclosure has been illustrated and described by referring to certain embodiments of the present disclosure. However, it should be understood by those skilled in the art that various changes in the forms and details may be made without departing from the principles and scope of the present disclosure.

What is claimed is:

1. A method for obtaining a final complete resource, comprising:
obtaining a blob image, the blob image being at least a part of the final complete resource shown in an image form;
extracting rough blob information from the blob image through image recognition, the rough blob information containing at least two characters or words recognized from the blob image;
searching for a candidate complete resource corresponding to the blob image according to the rough blob information; and
determining the final complete resource according to the candidate complete resource.

2. The method according to claim 1, wherein searching for the candidate complete resource includes:
searching for the candidate complete resource in a self-built search engine and resource library according to the rough blob information; and
invoking a third-party search service if the candidate complete resource is not found in the self-built search engine and resource library.

3. The method according to claim 1, wherein searching for the candidate complete resource includes:
determining whether a word frequency of a character or word is lower than a predetermined value; and
removing the character or word from the rough blob information if the character or word is random or if the word frequency of the character or word is lower than the predetermined value.

4. The method according to claim 1, wherein searching for the candidate complete resource includes:
searching for the candidate complete resource directly; or
attempting to access and search using an account set by a user if the candidate complete resource requires login or authorization.

5. The method according to claim 1, further comprising, after searching for the candidate complete resource:
comparing the rough blob information with the candidate complete resource;
revising the rough blob information using the candidate complete resource according to a comparison result; and
searching for the candidate complete resource in a smaller range according to the revised rough blob information.

6. The method according to claim 1, further comprising, after determining the final complete resource:
storing the final complete resource in a server.

7. The method according to claim 1, further comprising, after determining the final complete resource:
displaying the final complete resource on a screen of a client device;
receiving an input signifying a determination result for the final complete resource from an input device of the client device; and
modifying, according to the input, at least one of a method of extracting the rough blob information or a method of searching for the candidate complete resource.

8. A method for saving reading on an intelligent mobile terminal, comprising:
scanning an image library automatically to screen out a blob image;
extracting rough blob information from the blob image through image recognition, the rough blob information containing at least two characters or words recognized from the blob image;
searching for a reading resource corresponding to the blob image as a candidate complete resource according to the rough blob information; and
determining a final complete resource according to the candidate complete resource.

9. The method according to claim 8, further comprising, before scanning the image library automatically to screen out the blob image:
receiving, by the intelligent mobile terminal, a screen capturing signal;
obtaining at least one screenshot of reading contents displayed on a screen according to the screen capturing signal; and
storing the at least one screenshot in the image library,
wherein the blob image screened out from the image library is one of the at least one screenshot.

10. The method according to claim 9, further comprising, before obtaining the at least one screenshot:
requesting, by a reading saving application, a permission to read the image library,
wherein scanning the image library includes automatically detecting, by the reading saving application in a background, whether a new screenshot is received, before a user opens the reading saving application.

11. The method according to claim 8, further comprising, after extracting the rough blob information:
determining whether the rough blob information belongs to a category including a part of an article, a part of forum post, all or a part of a social networking post, or an article introduction; and
determining a manner of searching and obtaining the candidate complete resource according to the category to which the rough blob information belongs.

12. The method according to claim 8, wherein scanning the image library to screen out the blob image includes screening out the blob image according to at least one of:
image meta-data including basic attributes of an image file that is capable of being read out without decoding pixel information of the image file;
small region features; or
overall image features.

13. The method according to claim 8, further comprising, before extracting the rough blob information:
preprocessing the blob image by recognizing and extracting areas containing valid information, binarizing a text area, and compressing.

14. The method according to claim 8, wherein extracting the rough blob information includes extracting the rough blob information from the blob image through Optical Character Recognition.

15. A system for obtaining a final complete resource, comprising:
a blob image obtaining module configured to obtain a blob image, the blob image being at least a part of the final complete resource shown in an image form;
an extracting module configured to extract rough blob information from the blob image through image recognition, the rough blob information containing at least two characters or words recognized from the blob image;
a searching module configured to search for a candidate complete resource corresponding to the blob image according to the rough blob information; and
a final complete resource determining module configured to determine the final complete resource according to the candidate complete resource.

16. The system according to claim 15, wherein the searching module includes:
a self-built searching submodule configured to search for the candidate complete resource in a self-built search engine and resource library according to the rough blob information;
a third-party searching submodule configured to invoke a third-party search service if the candidate complete resource is not found in the self-built search engine and resource library.

17. The system according to claim 15, wherein the searching module includes:
a word frequency determining submodule configured to determine whether a word frequency of a character or word in the rough blob information is lower than a predetermined value; and
a removing submodule configured to remove the character or word from the rough blob information if the character or word is random or if the word frequency of the character or word is lower than the predetermined value.

18. The system according to claim 15, wherein the searching module includes:
a direct-searching submodule configured to search for the candidate complete resource directly; and
a login-searching submodule configured to attempt to access and search using an account set by a user if the candidate complete resource requires login or authorization.

19. The system according to claim 15, further comprising:
an iterative comparing and revising module configured to:
compare the rough blob information and the candidate complete resource iteratively,
revise the rough blob information using the candidate complete resource according to a comparison result, and
search for the candidate complete resource in a smaller range according to the revised rough blob information.

20. The system according to claim 15, further comprising:
a storing module configured to store the final complete resource in a server after the final complete resource determining module determines the final complete resource.

21. The system according to claim 15, further comprising:
a displaying module configured to display the final complete resource on a screen of a client device; and
a modifying module configured to:
receive an input signifying a determination result for the final complete resource from an input device of the client device, and
modify, according to the input, at least one of a method of extracting the rough blob information or a method of searching for the candidate complete resource.

22. A system for saving reading on an intelligent mobile terminal, comprising:
an extracting module configured to extract rough blob information from a blob image through image recognition after scanning an image library automatically to screen out the blob image, the rough blob information containing at least two characters or words recognized from the blob image;
a searching module configured to search for a reading resource corresponding to the blob image as a candidate complete resource according to the rough blob information; and
a final complete resource determining module configured to determine a final complete resource according to the candidate complete resource.

23. The system according to claim 22, further comprising:
a screenshot acquiring module configured to obtain at least one screenshot of reading contents displayed on a screen according to a screen capturing signal received by the intelligent mobile terminal; and
an image storing module configured to store the at least one screenshot in the image library.

24. The system according to claim 22, further comprising:
a preprocessing module configured to preprocess the blob image by recognizing and extracting areas containing valid information, binarizing a text area, and compressing.
